(19) United States
(12) Patent Application Publication
(10) Pub. No.: US 2005/0196490 A1
(43) Pub. Date: Sep. 8, 2005

(54) Divided packaging to retain product freshness and/or to increase variety

(76) Inventors: Jodi S. Krupp, Columbus, OH (US); John A. Krupp, Columbus, OH (US)

Correspondence Address: MICHAEL A. FORHAN;ELEY LAW FIRM CO., SUITE 311, 7870 OLENTANGY RIVER RD., COLUMBUS, OH, 43235, US

(21) Appl. No.: 11/072,581

(22) Filed: Mar. 4, 2005

Related U.S. Application Data
(60) Provisional application No. 60/550,196, filed on Mar. 4, 2004.

(51) Int. Cl. C12C 1/027

(52) U.S. Cl. 426/106

(57) ABSTRACT

A divided packaging container. The container comprises a base portion, a side portion, a plurality of internal, separate compartments, and a plurality of removable lids corresponding to the compartments. Access to each compartment is accomplished by removal of a corresponding lid. In various embodiments the containers may be generally horizontally or vertically oriented.

This application claims priority to U.S. provisional application 60/550,196, filed Mar. 4, 2004, the contents of which are hereby incorporated by reference.

### FIELD

This invention relates to product packaging. In particular, this invention relates to a system of divided packaging for products such as snack food, coffee and cereal to retain freshness and/or to increase the variety of product offered in a single package.

### BACKGROUND

Consumer products such as cereal, pretzels, chips, nuts, cookies, coffee, and the like are often sold in packages with more than one serving. The packaging is typically sealed in such a way that the product retains its freshness until the package is opened. Once opened, the entire contents of the product are exposed to the environment, causing ingress of contaminants such as air, moisture and bacteria. This interaction with the environment causes the product to begin aging. In some cases, the entire product is consumed in a short period of time such that deterioration of the product is not noticed. Frequently, though, by the time the last of the product is consumed, the original product freshness has been lost and the quality of the product has diminished.

Further, it is common for consumers to purchase items in larger quantities in order to take advantage of a reduced cost per unit measure of the items. However, consumers are often reluctant to purchase a large quantity of an item that may become stale if not entirely consumed within a relatively short period of time. However, if products were able to retain their freshness longer, consumer satisfaction would be higher and manufacturers could sell more products in larger quantities at higher profits.

Additionally, a product with different varieties or flavors provided in a common container is desirable. However, some means of separating the varieties and flavors is needed. In particular, a durable means of separating the product is desired such that the separating means remains in place after a portion of the packaging is opened.

Prior attempts at providing divided packaging include individual pouches bundled within a larger external package. This increases the usable life of the product; however, it is usually much easier to handle a product in the larger external container. In particular, granular or free-flowing products that are dispensed with a scoop or spoon, such as coffee, need a sturdy package and cannot be “pouched.”

There is a need for sturdy packaging with individual stay-fresh dividers or compartments that provide consumers with the ability to purchase larger quantities (with or without different varieties or flavors) of an item and provide an extended usable life for the product.

### SUMMARY

According to an embodiment of the present invention, a divided container is disclosed for use with products such as snack foods, coffee, cereal and other dry foodstuffs to retain freshness and/or provide variety of the product. A plurality of vertically or horizontally oriented dividers are incorporated into existing or new packaging designs. The dividers separate the product into compartments. Each compartment may be individually sealed in any conventional manner, such as according to original sealing specifications (i.e. vacuum or otherwise sealed).

In one embodiment of the present invention the compartments are horizontally oriented. Horizontal dividers may be positioned generally parallel to each other and the uppermost lid of the package and only allow the consumer to use the individual compartments consecutively. Horizontal dividers typically separate only one variety of a particular product because the compartments can only be used consecutively. As the user finishes the product in the uppermost compartment, the next separating freshness seal is removed or penetrated to reveal more factory-fresh product in the next, lower compartment.

In another embodiment of the present invention the compartments are vertically oriented. Vertical packaging includes dividers that permit the consumer to use the individual compartments concurrently or consecutively. Vertical dividers may be parallel or intersecting. If the package contains individually sealed compartments of same variety of the product, the consumer may wish to finish one compartment before opening the next to retain maximum freshness. If the package contains more than one variety or different products altogether, the compartments may be opened at the same time. For example, this type of division may be used for decaffeinated and regular coffee. A consumer may wish to use brew regular coffee in the morning and decaffeinated coffee in the evening. Furthermore, different varieties of nuts or popcorn can be packaged together without mixing flavors. Removable individual seals may be positioned proximate the top of the dividers.

An aspect of the present invention is a divided packaging container. The container comprises a base portion, a side portion, a plurality of internal, separate compartments, and a plurality of removable lids corresponding to the compartments. Access to each compartment is accomplished by removal of a corresponding lid.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a cutaway view of a packaging system according to an embodiment of the present invention, showing horizontally oriented compartments;

FIG. 2A is a cutaway view of a packaging system according to an embodiment of the present invention, showing vertically oriented compartments; and

FIG. 2B is a top view of the packaging system of FIG. 2A.

### DETAILED DESCRIPTION

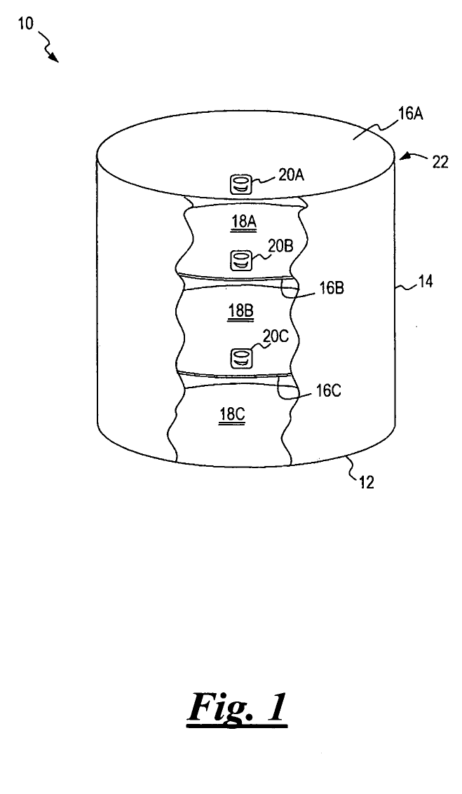

A divided packaging container 10 according to an embodiment of the present invention is depicted in FIG. 1. Container 10 comprises a base portion 12, a side portion 14, and a first removable lid 16A. Container 10 further comprises a plurality of horizontally oriented compartments 18. In the embodiment shown in FIG. 1, container 10 comprises three separate compartments 18A, 18B and 18C, but other embodiments may have a greater or fewer number of compartments. Compartments 18A-18C are divided by a plurality of lids 16. In the embodiment shown in FIG. 1, container 10 comprises a total of three lids 16A, 16B and 16C, though a greater or lesser number of lids may be utilized. Each of lids 16A-16C may be detached from side portion 14 by pulling upwardly on a pull-tab 20. Each of lids 16A-16C has a corresponding pull-tab 20A-20C, as shown in FIG. 1.

Base portion 12, side portion 14, lids 16 and pull tabs 18 may be made of any conventional material compatible with the product to be stored by container 10, such as plastics and metals. Further, compartments 18 may be sealed in any conventional manner compatible with the product to be stored by container 10, such as vacuum sealing.

In operation, a user first removes lid 16A by pulling upwardly on pull-tab 20A to gain access to compartment 18A. Compartment 18A may contain any desired dry product including, without limitation, coffee, cereal, pretzels, chips, nuts and cookies. Product in compartments 18B and 18C remain sealed by lids 16B and 16C respectively, retaining the freshness of product in those compartments. When product in container 18A is consumed, the user removes lid 16B by pulling on pull-tab 20B, thereby gaining access to compartment 18B. Product in compartment 18C remains sealed by lid 16C, thereby retaining the freshness of product in that compartment. Likewise, when product in compartment 18B is consumed, the user removes lid 16C by pulling on pull-tab 20C, thereby gaining access to compartment 18C.

In one embodiment of the present invention, compartments 18A, 18B and 18C may contain a like product. In other embodiments some or all of compartments 18A-18C may contain different product, such as different flavors of coffee, providing the user with a “variety package” in a single container 10.

A detachable cover (not shown) may be coupled to an upper portion 22 of container 10 when the container is not in use, to extend the freshness of the product in the opened compartment 18 of the container.

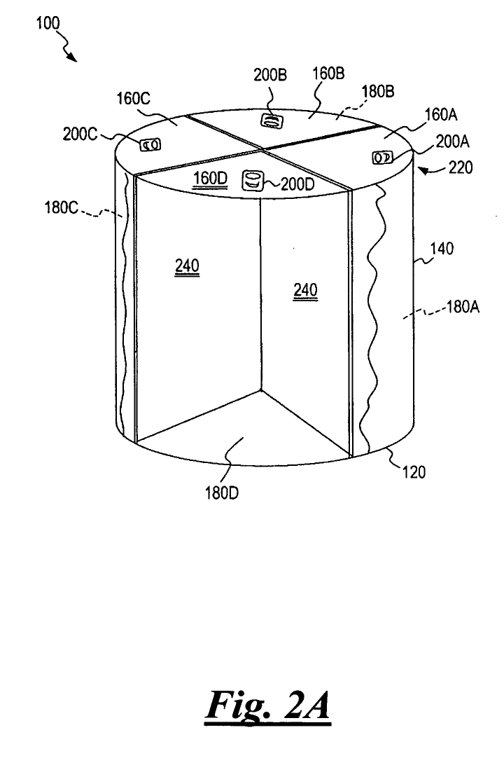

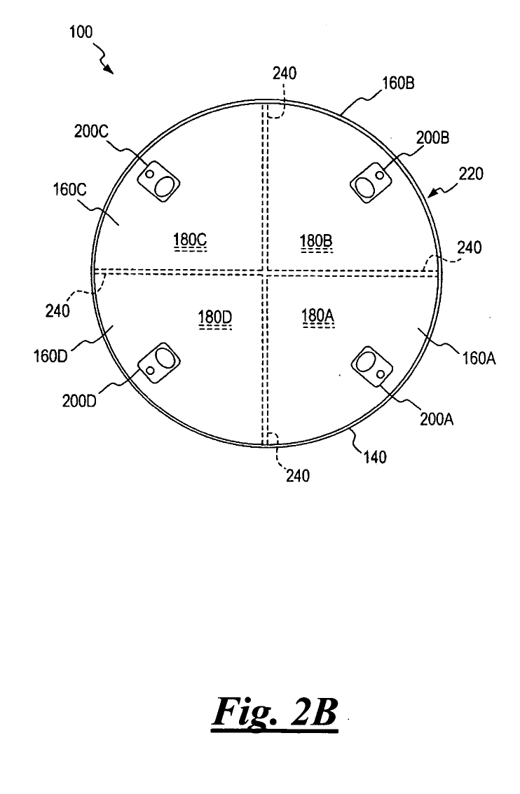

A divided packaging container 100 according to an alternate embodiment of the present invention is shown in FIGS. 2A and 2B. Container 100 comprises a base portion 120, a side portion 140, and a plurality of removable lids 160. Container 100 further comprises a plurality of vertically oriented compartments 180. In the embodiment of the present invention shown in FIGS. 2A and 2B, container 100 comprises four compartments 180A, 180B, 180C and 180D, but other embodiments may have a greater or fewer number of compartments.

Compartments 180A-180D are formed by a plurality of vertically oriented dividers 240, and are closed by corresponding removable lids 160A, 160B, 160C and 160D. Each of lids 160A-160D has a corresponding pull-tab 200A-200D, as shown in FIGS. 2A and 2B. Each of lids 160A-160D may be detached from container 100 by pulling upwardly on the associated pull-tab 200.

Base portion 120, side portion 140, lids 160 and pull tabs 180 maybe made of any conventional material compatible with the product to be stored by container 100, such as plastics and metals. Further, compartments 180 may be sealed in any conventional manner compatible with the product to be stored by container 100, such as vacuum sealing.

With continued reference to FIGS. 2A and 2B, in operation a user removes at least one lid 160, using a corresponding pull-tab 200, to gain access to a corresponding compartment 180. Each compartment 180 may contain any desired product including, without limitation, coffee, cereal, pretzels, chips, nuts, cookies and other dry foodstuffs. Any number of compartments 180A-180D may be opened while other compartments may remain sealed to retain freshness.

A detachable cover (not shown) may be coupled to an upper portion 220 of container 100 when the container is not in use, to extend the freshness of the product in opened compartments 180 of the container.

In one embodiment of the present invention, compartments 180A, 180B, 180C, and 180D may contain a like product. In other embodiments some or all of compartments 180A-180D may contain different product, such as different flavors of coffee, providing the user with a “variety package” in a single container 100. In still other embodiments compartments 180A-180D may comprise ingredients to be mixed together, such as for preparation of a pre-packaged food product.

The present invention has been described with reference to its application with food products. However, one skilled in the art will recognize that the present invention may be used to store and dispense any edible or non-edible material such as, without limitation, hardware, electrical components and liquids. Likewise, the compartments 18 and 180 of FIGS. 1, 2A and 2B may contain ingredients for mixture at a point of use, such as epoxies. Similarly, the compartments 18 and 180 of FIGS. 1, 2A and 2B may be utilized to contain products having a short shelf life after exposure to air, such as adhesives and sealants.

While this invention has been shown and described with respect to a detailed embodiment thereof, it will be understood by those skilled in the art that changes in form and detail thereof may be made without departing from the scope of the claims of the invention.

1. A divided packaging container comprising:
a base portion;
a side portion;
a plurality of internal, separate compartments; and
a plurality of removable lids corresponding to the compartments,
wherein access to each compartment is accomplished by removal of a corresponding lid.

2. The divided packaging container of claim 1 wherein the compartments are generally horizontally oriented.

3. The divided packaging container of claim 1 wherein the compartments are generally vertically oriented.

4. The divided packaging container of claim 1 wherein the lids further include a pull tab.

5. The divided packaging container of claim 1 wherein the compartments contain a like product.

6. The divided packaging container of claim 1 wherein at least one compartment contains a different product than the other compartments.

7. The divided packaging container of claim 1 wherein the compartments contain ingredients to be mixed together.

8. The divided packaging container of claim 1, further comprising a detachable cover.

9. A divided packaging container comprising:
a base portion;
a side portion;
a plurality of generally horizontally oriented internal, separate compartments; and
a plurality of removable lids corresponding to the compartments, wherein the lids further include pull tabs,
wherein access to each compartment is accomplished by removal of a corresponding lid.

10. The divided packaging container of claim 9 wherein the compartments contain a like product.

11. The divided packaging container of claim 9 wherein at least one compartment contains a different product than the other compartments.

12. The divided packaging container of claim 9 wherein the compartments contain ingredients to be mixed together.

13. The divided packaging container of claim 9, further comprising a detachable cover.

14. A divided packaging container comprising:
a base portion;
a side portion;
a plurality of generally vertically oriented internal, separate compartments; and
a plurality of removable lids corresponding to the compartments, wherein the lids further include pull tabs,
wherein access to each compartment is accomplished by removal of a corresponding lid.

15. The divided packaging container of claim 14 wherein the compartments contain a like product.

16. The divided packaging container of claim 14 wherein at least one compartment contains a different product than the other compartments.

17. The divided packaging container of claim 14 wherein the compartments contain ingredients to be mixed together.

18. The divided packaging container of claim 14, further comprising a detachable cover.
